(19) United States
(12) Patent Application Publication
(10) Pub. No.: US 2007/0234416 A1
(43) Pub. Date: Oct. 4, 2007

(54) GATEWAY DEVICE, TERMINAL, AND NETWORK DEVICE

(75) Inventors: Naoki MATSUOKA, Kawasaki-shi (JP); Masato OKUDA, Kawasaki-shi (JP); Haruyuki TAKEYOSHI, Kawasaki-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/760,038

(22) Filed: Jun. 8, 2007

Related U.S. Application Data
(63) Continuation of application No. PCT/JP05/00085, filed on Jan. 6, 2005.

(51) Int. Cl. G06F 15/16; G06F 17/00; G06F 9/00

(52) U.S. Cl. 726/12

(57) ABSTRACT

A terminal on the first network, a gateway device connected between the first and second networks, and a network device on the second network enable the terminal to independently and seamlessly use a plurality of network devices and to seamlessly use a network device on the first network and the network device on the second network. The network device indirectly or directly provides the terminal and the gateway device with terminal behavior information and proxy processing behavior information in which a behavior required to use the device itself is described, or provides the gateway device with gateway functional module information including the terminal behavior information and the proxy processing behavior information.

### CROSS-REFERENCE TO RELATED APPLICATION

This application is a continuation of International Application PCT/JP2005/000085 filed on Jan. 6, 2005, the contents of which are herein wholly incorporated by reference.

### BACKGROUND OF THE INVENTION

1. Field of the Invention

The present invention relates to a gateway device, a terminal, and a network device, and in particular to a terminal connected to a first network, a gateway device connected between the first network and a second network, and a network device connected to the second network.

With the recent spread of broadband lines having high-speed and broadband characteristics, video distribution services for digital household electrical appliances using the Internet have become remarkable. In these video distribution services, an environment where contents of a plurality of network devices with different specifications are seamlessly available has been required to be realized.

2. Description of the Related Art

FIG. 11 shows a prior art content distribution system network composed of a home network (the first network) 400, the Internet (the second network) 500, and a gateway device 200a connected between the networks 400 and 500. To the home network 400, a home server 101 and indoor terminals (such as Set Top Box, hereinafter occasionally referred to simply as terminals) 100a_1 and 100a_2 are connected. To these terminals 100a_1 and 100a_2, a receiving set (TV) 110a is further connected. To the Internet 500, network servers 300a_1 and 300a_2 (network devices, hereinafter occasionally represented by a reference numeral 300a) respectively required for service providers 301_1 and 301_2 are further connected.

The service providers 301_1 and 301_2 respectively provide Internet services by unique methods such as unique protocols 302_1 and 302_2. Namely, the Internet services are respectively provided to the digital household electrical appliance 110a through the network servers 300a_1 and 300a_2, and the indoor terminals 100a_1 and 100a_2 corresponding to the unique protocols 302_1 and 302_2 of the servers 300a_1 and 300a_2.

In such a service providing system, there are problems (1)-(3) as follows: (1) A plurality of indoor terminals 100a_1, 100a_2, and the like are required respectively corresponding to the unique protocols 302_1, 302_2, and the like; (2) Since setting indoor terminals for locations is required when services are used in a plurality of indoor locations, convenience for service users becomes worse; (3) The home server 101 and the digital household electrical appliance 110a can not be mutually connected. Namely, since the indoor terminal is a provider's proper device, a mutual connection with other home network standard devices within the home network 400 can not be performed, and contents of the home network 400 and the Internet 500 are used by different digital household electrical appliances, so that a seamless service environment is not available.

FIG. 12 shows a content distribution method for solving the above-mentioned problems (1)-(3). The home network 400 over domestic devices aims at a mutual connection between indoor appliances. In standards body such as UPnP (Universal Plug and Play) FORUM and DLNA, a specification different from the Internet standard has been standardized, so that an environment where contents are freely distributed is being prepared at home. The network configuration in the method shown in FIG. 12 is different from that shown in FIG. 11 in that e.g. a protocol based on the UPnP is adopted within the home network 400 and a content distribution between the home server 101 and a digital household electrical appliance (TV) 110b is performed with the UPnP.

Also, the arrangement of FIG. 12 is different from that of FIG. 11 in that a gateway device 200b is provided with a protocol converter 50 which converts the unique protocol 302_1 or the like into a UPnP protocol 303_1. The protocol converter 50 converts the unique protocols 302_1-302_5 on the Internet 500 respectively into the protocols 303_1-303_5 in conformity with the UPnP. Thus, it becomes possible for the digital household electrical appliance 110b to seamlessly use contents of the home server 101, the network server 301_1, and the like (see e.g. patent document 1).

Patent document 1: Japanese Patent Application Laid-open No. 2002-196990

The mode using the gateway device 200b which performs a protocol conversion between the indoor terminal 100a and the network server 300a can absorb the difference between the protocols of the home network 400 and the Internet 500 by a protocol conversion function.

However, in an actual service environment, service processing of the network server 300a has to be compliant with not only a simple 1:1 protocol conversion (e.g. between the protocols 302_1 and 303_1) but also a service processing flow (e.g. processing of the protocol 302_3 is performed before that of the protocol 302_4) prescribed by the service provider. Accordingly, in the arrangement shown in FIG. 12, the gateway device 200b neither can control the service processing flow nor can provide services unique to the provider to the digital household electrical appliance 110b.

### SUMMARY OF THE INVENTION

It is accordingly an object of the present invention to provide a gateway device, a terminal, and a network device, wherein the gateway device connected between the first and second networks enables the terminal connected to the first network to independently and seamlessly use a plurality of network devices on the second network, the terminal to independently and seamlessly use the network devices on the first and second networks, and the network devices to provide necessary information to the terminal and the gateway device.

In order to achieve the above-mentioned object, a gateway device according to the present invention comprises: a terminal behavior information storing portion storing terminal behavior information in which a behavior required for a terminal connected to a first network to use a network device connected to a second network is described; and an advertisement processor providing the terminal behavior information to the terminal.

FIG. 1 shows a principle of a terminal (indoor terminal) 100, a gateway device 200, and a network device (e.g. network server) 300 (reference numeral 300 represents referring numerals 300_1 and 300_2). The gateway device 200 is connected between the first network (e.g. home network) 400 and the second network (e.g. Internet) 500. The terminal 100 is further connected to the first network 400, and the network devices 300_1 and 300_2 are further connected to the second network 500. The network devices 300_1 and 300_2 are e.g. the network servers 300_1 and 300_2 of service providers 300_1 and 300_2 which provide services respectively.

FIG. 2 shows a basic arrangement of the terminal 100, the gateway device 200, and the network server 300 shown in FIG. 1. The gateway device 200 is provided with an advertisement processor 22 and a terminal behavior information storing portion 24. Terminal behavior information (e.g. control process information for controlling the network servers 300_1 and 300_2 respectively, and protocol information for using services) in which a behavior required for the terminal 100 connected to the home network 400 to communicate with the network devices 300_1 and 300_2 connected to the second network is described is stored in the terminal behavior information storing portion 24. The advertisement processor 22 provides the terminal behavior information corresponding to the network devices 300_1 and 300_2 respectively to the terminal 100 with e.g. a UPnP (Universal Plug and Play) protocol.

Thus, it becomes possible for the terminal 100 to receive services from the network servers 300_1 and 300_2 based on the terminal behavior information corresponding to the network servers 300_1 and 300_2. Namely, it becomes possible for a single terminal 100 to receive services from a plurality of network servers 300_1 and 300_2 whose protocols are different from each other. That is to say, the operation of the terminal is reversely controlled by the terminal behavior information.

Also, the present invention according to the above-mentioned present invention may further comprise an information acquiring portion acquiring the terminal behavior information from the network device to be stored in the terminal behavior information storing portion.

Namely, as shown in FIG. 2, the gateway device is further provided with an information acquiring portion 21. This information acquiring portion 21 acquires the terminal behavior information from the network device 300_1 to be stored in the terminal behavior information storing portion 24. Thus, it becomes possible for a maintenance person of the gateway device to acquire the terminal behavior information from the network servers 300_1 and 300_2 without entering the terminal behavior information corresponding to e.g. the network servers 300_1 and 300_2 respectively. Also, it becomes possible for the gateway device to add/update the terminal behavior information acquired from a plurality of network devices.

Also, the present invention according to the above-mentioned present invention may further comprise a proxy (agent) processing behavior information storing portion storing proxy processing behavior information for performing processing required to use the network device for the terminal, and a proxy processor performing proxy processing, when a proxy request of processing for the network device is received from the terminal, based on the proxy processing behavior information corresponding to the proxy request by referring to the proxy processing behavior information storing portion.

Namely, in FIG. 2, the gateway device is further provided with a proxy processor 25 and a proxy processing behavior information storing portion 26. This proxy processing behavior information storing portion 26 stores information (i.e. proxy processing behavior information) concerning processing for performing required processing to use the network device 300 for the terminal 100. The terminal 100 requests the gateway device 200 to perform processing to use the network device 300. It is supposed that the terminal behavior information includes the terminal behavior information for a proxy request of the processing. When receiving the proxy request from the terminal 100, the proxy processor 25 executes the proxy processing based on the proxy processing behavior information corresponding to the proxy request referring to the proxy processing behavior information storing portion 26.

Thus, it becomes possible for the gateway device 200 to execute processing corresponding to each network device 300 for the terminal 100, when e.g. the protocol of the first network is different from that of the second network. Also, it becomes possible for the gateway device 200 to execute processing for the network device 300 based on the proxy processing behavior information corresponding to each protocol, when the protocols 302_1 and 302_2 of the network devices 300_1 and 300_2 are different from each other.

Also, the present invention according to the above-mentioned present invention may further comprise an information acquiring portion acquiring the proxy processing behavior information from the network device to be stored in the proxy processing behavior information storing portion.

Namely, in FIG. 2, the gateway device is further provided with an information acquiring portion 21 (the same as the information acquiring portion 21 which acquires the above-mentioned terminal behavior information in FIG. 2). This information acquiring portion 21 acquires the proxy processing behavior information from e.g. the network device 300_1 to be stored in the proxy processing behavior information storing portion 26. Thus, it becomes possible for a maintenance person to acquire the proxy processing behavior information from the network servers 300_1 and 300_2 without entering the proxy processing behavior information corresponding to e.g. the network servers 300_1 and 300_2 respectively.

Also, in the present invention according to the above-mentioned present invention, the terminal behavior information may also include terminal behavior information for the terminal to request the proxy processor to perform proxy processing.

Also, in the present invention according to the above-mentioned present invention, the terminal behavior information may be compliant with a standard protocol of the first network. Thus, it becomes possible for e.g. the TV 110 (see FIG. 1) in a single indoor terminal 100 to use not only services of the indoor device (e.g. home server 101) on the first network but also services of the server 300 on the second network.

Also, in the present invention according to the above-mentioned present invention, the standard protocol may be compliant with UPnP.

Also, the present invention according to the above-mentioned present invention may further comprise an advertisement information storing portion storing advertisement information indicating information concerning the network device, and the advertisement processor may advertise the advertisement information to the first network.

Namely, as shown in FIG. 2, the gateway device 200 is further provided with an advertisement information storing portion 23, which stores advertisement information indicating information (URL (Uniform Resource Locator) based on URI (e.g. Uniform Resource Identifier) indicating a location where the terminal behavior information corresponding to the network device 300 exists) concerning the network device 300. The advertisement processor 22 advertises or broadcasts the advertisement information to the first network. Thus, the terminal 100 can recognize information concerning the network device which provides services on the second network, and can request predetermined terminal behavior information based on the information.

Also, in the present invention according to the above-mentioned present invention, the advertisement processor may provide the terminal behavior information to the terminal with a standard protocol of the first network.

Also, in the present invention according to the above-mentioned present invention, the first network may comprise a home network and the second network may comprise Internet.

Furthermore, in order to achieve the above-mentioned object, a gateway device according to the present invention comprises: an information acquiring portion acquiring, from a network device on a second network, gateway functional module information including an advertisement processing function for providing a terminal with terminal behavior information in which a behavior required for the terminal on a first network to use the network device is described and a proxy processing function performing proxy processing, when a proxy request of processing for the network device is received from the terminal, based on proxy processing behavior information in which a behavior required to perform the behavior by proxy is described, in response to the proxy request; and a storing portion storing the gateway functional module information to execute the advertisement processing function and the proxy processing function.

Namely, the gateway device 200 acquires gateway functional module information for executing e.g. a network protocol control for each service provider from the network device 300, thereby enabling a gateway function to be arbitrarily added/expanded upon addition of new services or expansion of existing services.

Also, in order to achieve the above-mentioned object, a terminal according to the present invention connected to a first network comprises: an information acquiring portion acquiring, from a gateway device connected between the first network and a second network, terminal behavior information in which a behavior required to use a network device connected to the second network is described; and a controller using the network device based on the terminal behavior information.

Namely, as shown in FIG. 2, the terminal 100 is connected to the first network (e.g. home network 400), and is provided with an information acquiring portion 11 and a controller 12. The information acquiring portion 11 acquires, from the gateway device 200, the terminal behavior information in which a behavior required to use the network device 300 (e.g. network servers 300_1 and 300_2) connected to the second network (e.g. the Internet) is described. The controller 12 uses the network device 300 based on the terminal behavior information corresponding to each network device.

Thus, it becomes possible for a single terminal 100 to use e.g. the network device 300_1 and 300_2 which operate with different unique protocols 302_1 and 302_2.

Also, in the present invention according to the above-mentioned present invention the terminal behavior information may include behavior information in which a behavior to request the gateway device to perform behavior required to use the network device by proxy is described.

Namely, the terminal behavior information may be behavior information which requests the gateway device 200 to perform behavior required to use the network device 300 by proxy. Thus, it becomes possible for the terminal to request the network device to use e.g. the network devices which operate with different unique protocols.

Also, in the present invention according to the above-mentioned present invention, the terminal behavior information may be compliant with a standard protocol of the first network and the standard protocol may be compliant with UPnP.

Thus, it becomes possible for a single indoor terminal 100 to use services not only of the indoor device (e.g. home server 101) on the first network but also of the server 300 on the second network.

Furthermore, in the present invention according to the above-mentioned present invention, the information acquiring portion may acquire the terminal behavior information from the network device for the gateway device. Thus, it becomes possible for the terminal 100 to directly acquire the terminal behavior information from the network device 300, and for the network device 300 to manage the behavior information in an integrated fashion. For example, in order to change a specification of the behavior information, the behavior information of the network device 300 has only to be updated.

In order to achieve the above-mentioned object, a network device according to the present invention comprises: an information management portion managing terminal behavior information in which a behavior required to use the device itself is described and proxy processing behavior information in which a behavior required for a gateway device having received a proxy request of the behavior to perform the behavior by proxy is described, and returning both of the behavior information requested; and a controller making the device itself available when a behavior based on the terminal behavior information or the proxy processing behavior information is received from a terminal or the gateway device.

Namely, as shown in FIG. 2, the network device 300 is provided with an information management portion 31 and a controller 32. The information management portion 31 manages terminal behavior information in which a behavior required for e.g. the indoor terminal 100 to use the device itself is described, and proxy processing behavior information in which a behavior required for the gateway device 200 to perform the behavior by proxy upon receiving a proxy request of the behavior for the device (terminal 100) directly using the device itself. When the terminal behavior information or the proxy processing behavior information is requested from e.g. the terminal 100 or the gateway device 200, the information management portion 31 returns the terminal behavior information to the terminal or the gateway device. The controller 32 makes the device itself available, for example, when a behavior (e.g. control message) based on the terminal behavior information or the proxy processing behavior information is received from the terminal 100 or the gateway device 200 respectively.

Thus, the network devices 300_1 and 300_2 enable the terminal 100 to use the devices themselves with the unique protocols of the devices themselves.

Also, in order to achieve the above-mentioned object, a network device according to the present invention comprises: an information management portion managing gateway functional module information including an advertisement processing function for providing a terminal with terminal behavior information in which a behavior required to use the device itself is described and a proxy processing function performing proxy processing, when a proxy request of processing for the device itself is received from the terminal, based on proxy processing behavior information in which a behavior required for a gateway device having received the proxy request of the behavior to perform the behavior by proxy is described, in response to the proxy request, and returning the gateway functional module information required; and a controller making the device itself available when a behavior based on the terminal behavior information or the proxy processing behavior information is received from the terminal or the gateway device.

Thus, it becomes possible for the network device to provide e.g. the gateway functional module for executing a service control per service provider to the gateway device, and to respond to a service use request from the gateway device. Also, in the network device, the information management portion 31 can easily manage an addition, an update, or the like of the gateway function, the terminal behavior information, and the proxy processing behavior information corresponding to e.g. a service addition or an expansion of the existing service.

Furthermore, in order to achieve the above-mentioned object, a network device according to the present invention comprises: a behavior information management portion managing terminal behavior information in which a behavior required to use the device itself is described or proxy processing behavior information in which a behavior required for a gateway device having received a proxy request of the behavior to perform the behavior by proxy is described; and an advertisement processor advertising a URI of the device itself for acquiring the behavior information to a terminal or the gateway device.

Namely, the network device is provided with a behavior information management portion and an advertisement processor. The behavior information management portion manages the terminal behavior information in which a behavior required to use the network device (only the device itself or including other network devices) is described, or the proxy processing behavior information in which a behavior required for the gateway device having received a proxy request of the behavior to perform the behavior by proxy is described. The advertisement processor advertises a URI of the device itself for acquiring the behavior information to a terminal or the gateway device. Thus, it becomes possible for a device requiring the behavior information of the network device to acquire the behavior information by accessing the URI. Also, it becomes possible for the behavior information management portion to manage the terminal behavior information in an integrated fashion, the proxy processing behavior information, or the addition/update of both behavior information.

As described above, the present invention is arranged so that the network device indirectly or directly provides the terminal behavior information and the proxy processing behavior information in which a behavior required to use the device itself is described respectively to the terminal and the gateway device, or provides gateway functional module information including the terminal behavior information and the proxy processing behavior information to the gateway device. Therefore, it becomes possible for the terminal connected to the first network to independently and seamlessly use the network devices on the second network.

Also, the present invention is arranged so that the gateway device 200 advertises the terminal behavior information to the terminals within the home network (first network) with a home network standard protocol, and the terminals request the service of the network device with the standard protocol based on the terminal behavior information. Therefore, it becomes possible for the terminals connected to the home network to independently and seamlessly use the network device on the home network and the network device on the second network (e.g. the Internet).

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a diagram showing a principle of a gateway device, a terminal, and a network device according to the present invention;

FIG. 2 is a block diagram showing a basic arrangement of a gateway device, a terminal, and a network device according to the present invention;

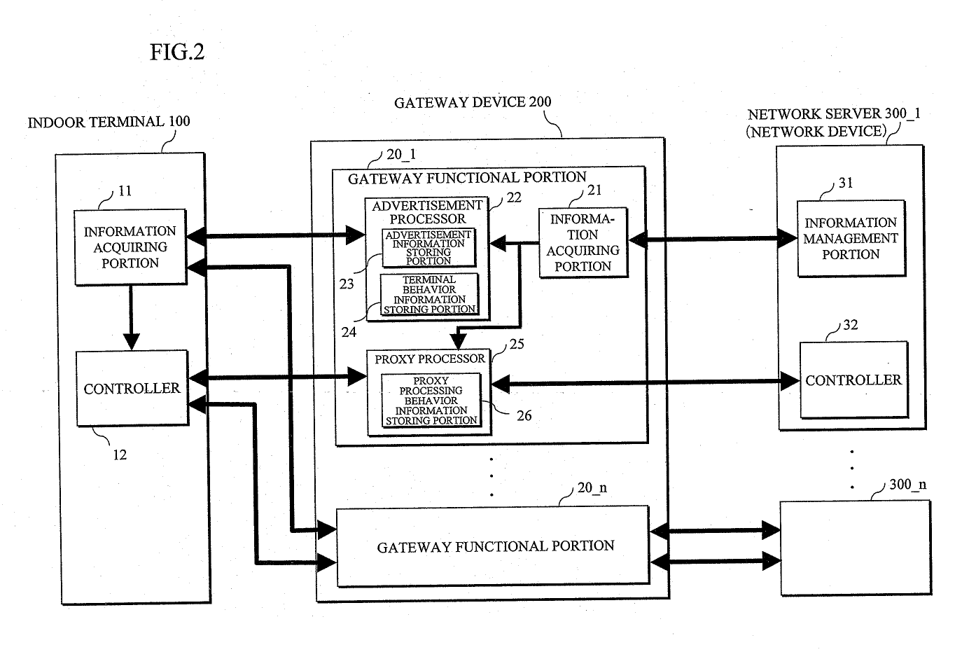

FIG. 3 is a block diagram showing an arrangement embodiment (1) of a gateway device, a terminal, and a network device according to the present invention;

FIG. 4 is a sequence diagram showing an operation embodiment (1) of a gateway device, a terminal, and a network device according to the present invention;

FIG. 5 is a diagram showing an example of an information advertisement which a gateway device according to the present invention transmits to a home network;

FIG. 6 is a diagram showing an example (1) of device service information which a gateway device according to the present invention transmits to a terminal;

FIG. 7 is a diagram showing an example (2) of device service information which a gateway device according to the present invention transmits to a terminal;

FIG. 8 is a diagram showing an example of terminal behavior information which a gateway device according to the present invention transmits to a terminal;

FIG. 9 is a block diagram showing an arrangement embodiment (2) of a gateway device, a terminal, and a network device according to the present invention;

FIG. 10 is a sequence diagram showing an operation embodiment (2) of a gateway device, a terminal, and a network device according to the present invention;

FIG. 11 is a diagram showing an example (1) of a content distribution system network composed of a prior art gateway device, terminal, and network device; and

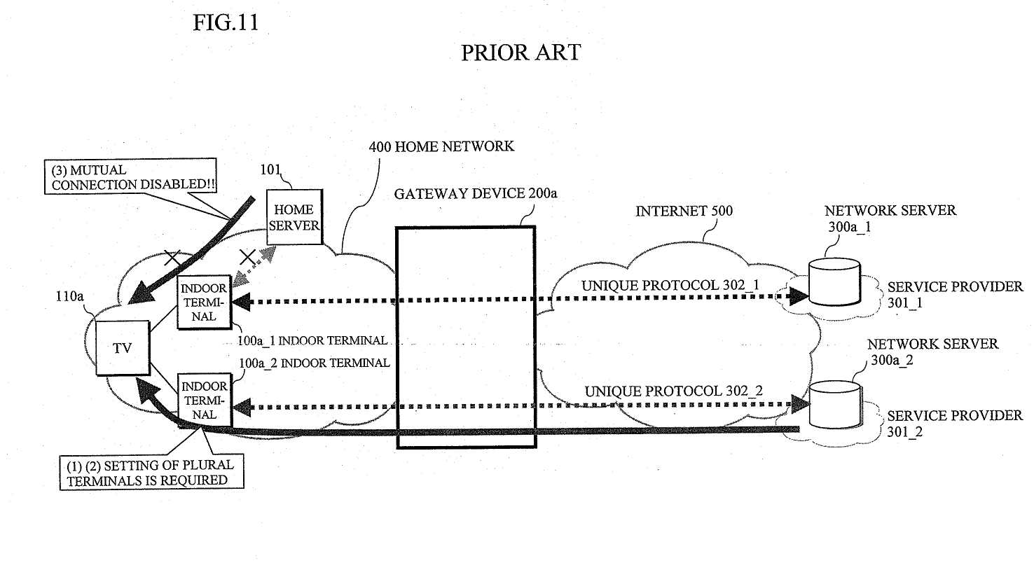

FIG. 12 is a diagram showing an example (2) of a content distribution system network composed of a prior art gateway device, terminal, and network device.

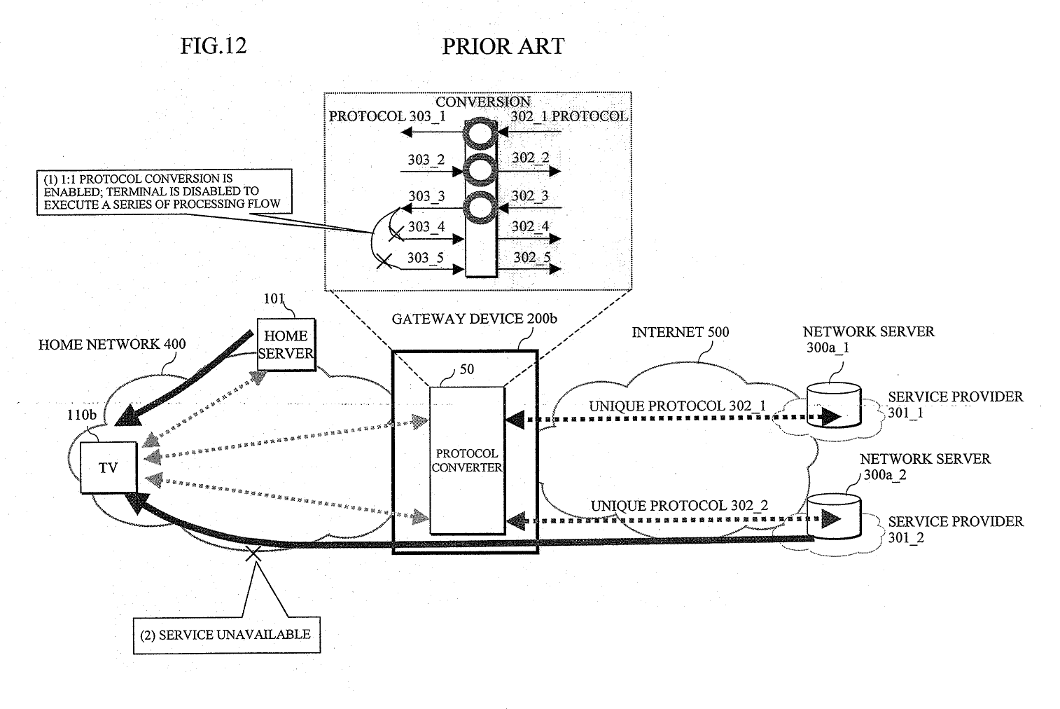

### DESCRIPTION OF THE EMBODIMENTS

### Embodiment (1)

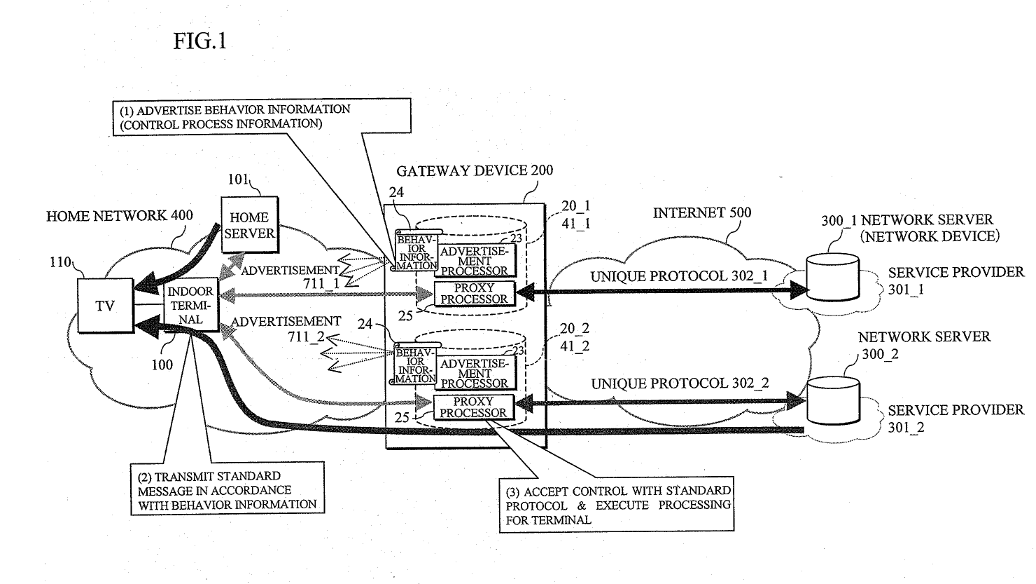

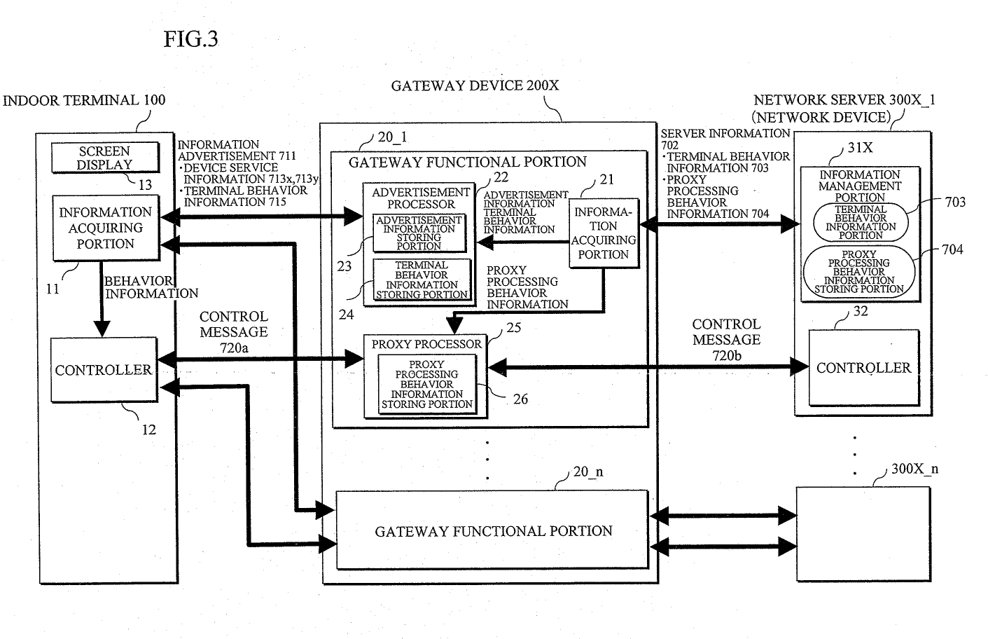

FIG. 3 shows an arrangement embodiment of the indoor terminal 100, a gateway device 200X, and a network server (network device) 300X where the reference numeral 300X represents reference numerals 300X_1-300X_n, or the like. The terminal 100 is connected to the gateway device 200X through the home network (first network; not shown in FIG. 3; see FIG. 1) 400. The network server (network device) 300X is connected to the gateway device 200X through the Internet (second network; not shown in FIG. 3; see FIG. 1) 500.

The terminal 100 is provided with the information acquiring portion 11, the controller 12, and a screen display 13. The gateway device 200X is provided with gateway functional portions 20_1-20_{—}n (hereinafter, occasionally represented by a reference numeral 20) respectively corresponding to the network servers 300X_1-300X_n. The gateway functional portion 20 is provided with the information acquiring portion 21, the advertisement processor 22, the advertisement information storing portion 23, the terminal behavior information storing portion 24, the proxy processor 25, and the proxy processing behavior information storing portion 26. In this arrangement embodiment, the advertisement information storing portion 23 and the terminal behavior information storing portion 24 are included in the advertisement processor 22, and the proxy processing behavior information storing portion 26 is included in the proxy processor 25. The network server 300X is provided with an information management portion 31X and the controller 32. The information management portion 31X manages the information of the network server 300X itself, the behavior information (already described) of the terminal 100, and the proxy processing behavior information of the gateway device 200X. Based on the information, the terminal 100 uses the services of the network server 300X through the gateway device 200X.

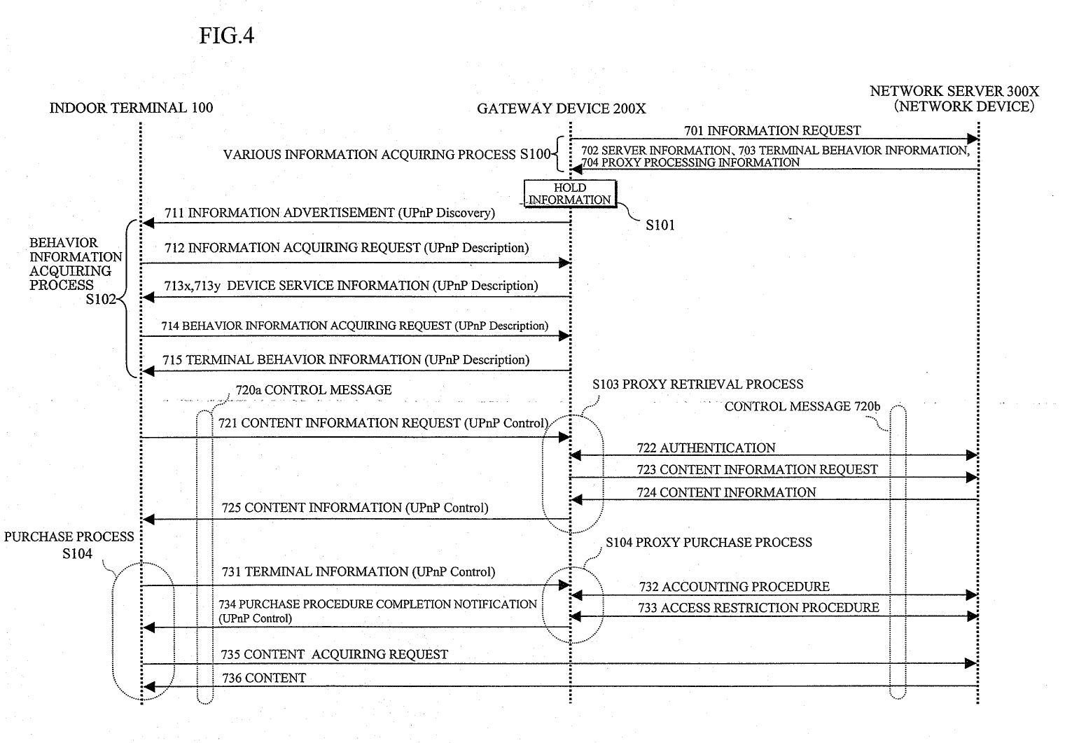

FIG. 4 shows an operation process example when the indoor terminal 100 shown in FIG. 3 uses services of the network server 300X through the gateway device 200X. This operation process example will now be described referring to FIG. 3. It is to be noted that UPnP is used for the standard protocol of the home network 400 (see FIG. 1), and the indoor terminal 100 and the gateway device 200X support the UPnP.

Step S100 (various information acquiring process): The gateway device 200X transmits to the network server 300X an information request 701 requesting server information (advertisement information or the like), terminal behavior information, and proxy processing behavior information. The network server 300X returns to the gateway device 200X requested server information 702, terminal behavior information 703, and proxy processing behavior information 704.

Step S101: The gateway device 200X stores the server information (advertisement information) 702, the terminal behavior information 703, and the proxy processing behavior information 704 received respectively in the advertisement information storing portion 23, the terminal behavior information storing portion 24, and the proxy processing behavior information storing portion 26. It is to be noted that once acquired, the information 23, 24, and 26 need not be acquired again by the gateway device 200X unless they are changed.

It is to be noted that a maintenance person may manually store the server information, the terminal behavior information, and the proxy processing behavior information respectively in the advertisement information storing portion 23, the terminal behavior information storing portion 24, and the proxy processing behavior information storing portion 26 in the gateway device 200X.

Step S102 (behavior information acquiring process): In the gateway device 200X, the advertisement processor 22 advertises the information advertisement 711 (UPnP Discovery) to the home network 400. Namely, the advertisement processor 22 advertises the network server 300X as a virtual gateway device. The indoor terminal 100 receives the information advertisement 711.

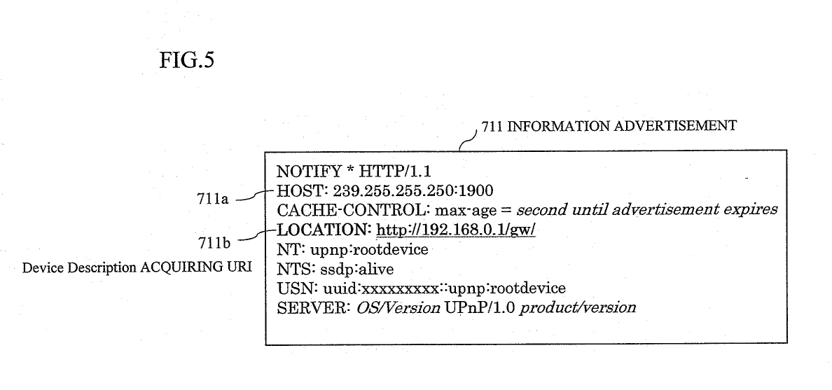

FIG. 5 shows one example of the information advertisement 711, which is a Discovery message of the UPnP, and includes HOST=“239.255.255.250:1900” (see 711a in FIG. 5) and LOCATION=“http://192.168.0.1/gw/” (see 711b in FIG. 5). HOST=“239.255.255.250:1900” is a multicast address, and the information advertisement 711 is advertised to all of the UPnP terminals (indoor terminal 100 or the like) within the network 400. Also, LOCATION=“http://192.168.0.1/gw/” indicates an address acquiring the Device Description, which will be described later.

In the indoor terminal 100, the information acquiring portion 11 accesses an address of LOCATION=“http://192.168.0.1/gw/” described in the information advertisement 711 in order to acquire detailed information of the device discovered by the received information advertisement 711, and transmits an information acquiring request (UPnP Description) 712 requesting device service information that is the detailed information of the device. In the gateway device 200X, the advertisement processor 22 receives the information acquiring request 712, and returns to the indoor terminal 100 device service information (=Device Description information: UPnP Description) 713x corresponding to the LOCATION=“http://192.168.0./gw/”.

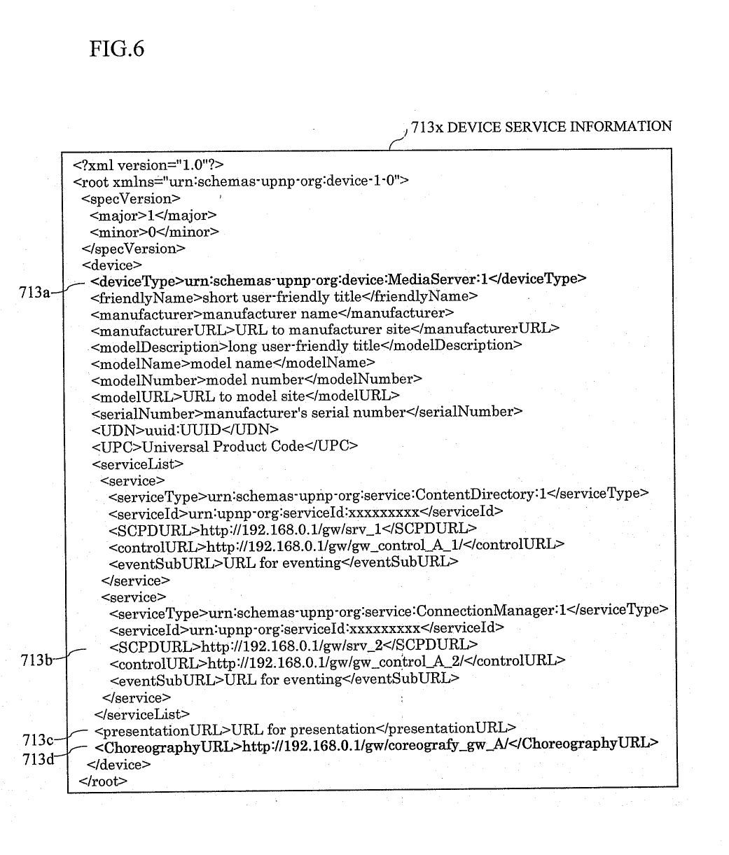

FIG. 6 shows the device service information 713x that is a device description message of an UPnP standard specification and includes a device name, a device type, service information held by the device, a transmitting destination URI of a control message, a transmitting destination URI of an event information subscription request, a service, and the like. The description thereof will be omitted because of the UPnP standard specification.

The device service information 713x of this embodiment adds and assigns a URI (value enclosed with Choreography URL tag: see reference numeral 713d) for acquiring the terminal behavior information in addition to the standard specification.

Furthermore in the embodiment (1), the device type of a virtual gateway device is advertised in the device service information 713x (see reference numeral 713a in FIG. 6) as “Media Server” of the home network standard in order to seamlessly connect the Internet 500 connecting the servers 300x and the home network 400.

The indoor terminal 100 accesses SCPDURL (see reference numeral 713b in FIG. 6) described in the acquired device service information (UPnP Description) 713x, whereby acquisition of the detailed information of the services provided by the device (server 300x) is enabled.

The indoor terminal 100 similarly accesses Choreography URL (see reference numeral 713c in FIG. 6), transmits the behavior information acquiring request (UPnP Description) 714, and acquires from the advertisement processor 22 of the gateway device 200X, behavior information 715 for using the server 300x.

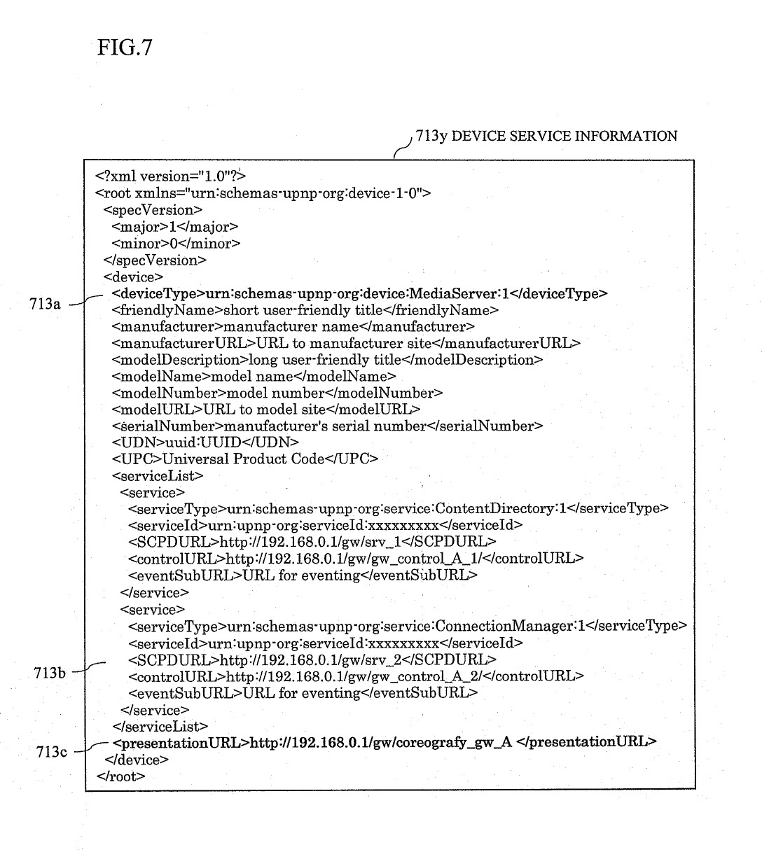

It is to be noted that while a new message tag (see reference numeral 713d in FIG. 6) is added to a UPnP message as means for advertising the terminal behavior information in the device service information 713x shown in FIG. 6, a URI of the terminal behavior information may be described in a Presentation URL (see reference numeral 713c) that is the standard information of the Device Description information, as shown in a modification in FIG. 7.

Namely, FIG. 7 shows device service information 713y in which a URI of the terminal behavior information is described as the Presentation URL. This device service information 713y is different from the device service information 713x shown in FIG. 6 in that the device service information 713y has no message tag 713d but indicates a URI (presentation URI) for acquiring the terminal behavior information on the message tag 713c. This Presentation URL is for notifying (displaying) various information of the device to the terminal 100. However, since it has no explicit intended usage and is not used, influence due to using the area is low. According to the device service information 713y, it becomes possible to notify the URI of the behavior information with the standard specification without adding a unique specification.

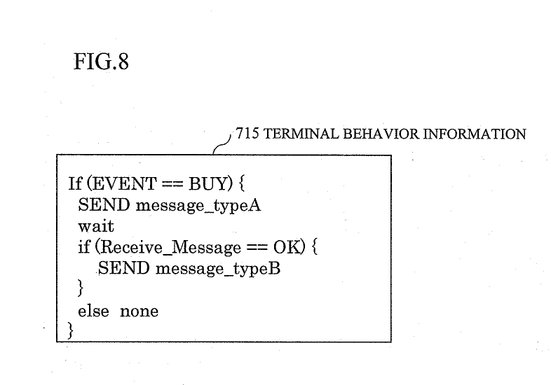

FIG. 8 shows the behavior information 715, in which an operation process for purchasing contents from the network server 300X_1 is indicated. Namely, the behavior information (operation process) for using a virtual gateway device (e.g. server 300X_1) is indicated in the behavior information 715. In this operation process, (1) a message of type A is transmitted, (2) a message indicating OK is waited, and (3) a message of type B is transmitted when the message is received.

It is to be noted that as another behavior information, behavior information or the like for retrieving contents held by the servers 300X can be mentioned. Also, while the terminal behavior information indicates the operation process by a description language like C language, any description language may be used as long as the description language can prescribe the process. For example, WSCI, BPEL₄WS, or the like which is a standard process flow description language may be used.

Also, the indoor terminal 100 acquires by the same process not only the information of the virtual gateway device but also the information of another terminal (not shown; e.g. home server 101 shown in FIG. 1) within the indoor home network 400. Thus, it becomes possible for the indoor terminal 100 to discover an indoor home network standard device, a virtual gateway function device (server 300X), and to acquire the terminal behavior information for using the virtual gateway function device.

Hereinafter, an operation process upon using service will be described referring to FIG. 4.

Step S103 (retrieval process): A user of the indoor terminal 100 discovers an indoor device (including virtual gateway device) at the above-mentioned step S102, and selects the virtual gateway device (server 300X) which provides network services. The controller 72 (see FIG. 3) of the indoor terminal 100 acquires from the information acquiring portion 11 the behavior information 715 (operation process of terminal 100 prescribed to purchase contents from the server 300X)for using the server 300X.

The user of the indoor terminal 100 transmits content information request (content retrieval message: e.g. UPnP Browse action) 721 in order to retrieve network contents. In the gateway device 200X, the proxy processor 25 of the gateway functional portion 20_1 analyzes a UPnP action included in the content information request 721 and converts the content information request 721 into proxy processing corresponding to the UPnP action, namely authentication processing 722 and content information request 723 (network server content retrieval message) based on e.g. the proxy processing behavior information preliminarily stored by the maintenance person in the proxy processing behavior information storing portion 26. The proxy processor 25 executes the authentication processing 722 with the network server 300X, and then transmits the content information request 723 to the network server 300X.

The network server 300X returns content information 724. The proxy processor 25 converts the received content information 724 into content information (UPnP response message: UPnP Control) 725 based on the proxy processing behavior information to be transferred to the terminal 700. Thus, it becomes possible for the terminal 100 to retrieve network contents by using the home network standard protocol. Thus, by repeating the content retrieval, the user of the terminal 100 can confirm contents which the user wants to watch.

Step S104 (content purchase process): The user of the indoor terminal 100 executes the operation process based on the terminal behavior information 715 shown in FIG. 8, and purchases the confirmed contents.

Namely, the controller 12 of the terminal 100 firstly transmits to the virtual gateway device (server 300X) terminal information 731 (notification message: UPnP Control, equivalent to message of type A shown in FIG. 7) including an intention of purchasing predetermined content and information (e.g. IP address, terminal identifier, or the like) of the device itself based on the behavior information 715 received from the information acquiring portion 11, and waits for its response. In the gateway device 200X, the proxy processor 25 executes a predetermined purchase process (accounting procedure 732 and access restriction procedure 733) corresponding to the terminal information 731 by referring to e.g. the proxy processing behavior information preliminarily stored by the maintenance person. Namely, the proxy processor 25 sequentially executes the accounting procedure 732 and the access restriction procedure 733 with the network server 300X for the terminal 100, completes the procedures 732 and 733, and then transmits to the terminal 100 a purchase procedure completion notification 734 (UPnP Control; equivalent to reception message (Receive_Message=“OK”) in FIG. 8) indicating the completion of the purchase procedure.

In the terminal 100, the controller 12 ends the processing when the received purchase procedure completion notification 734 does not indicate “OK”. When it indicates “OK”, the controller 12 transmits a content acquiring request 735 (equivalent to message of type A in FIG. 7) to the network server 300X and receives contents 736 from the server 300X. Namely, the terminal 100 operates in conformity with the behavior information, so that the gateway device 200X performs by proxy a series of procedure processing required for the retrieval process and content purchase process. Thus, a purchase procedure (authentication processing, accounting procedure, access restriction procedure, or the like) which is bothersome for a user is automated, and a network service can be used with the home network standard terminal 100.

It is to be noted that since a service control method compliant with the UPnP standard specification is used, another home device (home device 101 or the like) within the home network can be used by the completely same method. When this home device is used, a specific terminal behavior information is not required. As a result, it becomes possible for e.g. terminal 100 to access the home server 101 on the home network 400 and the server 300X (actually virtual gateway functional portion 20) on the Internet 500 to acquire contents, to display the list of the Internet contents and the home server contents concurrently on the screen display 13, and to use the Internet contents and the home server contents selected from the list by the same operation method.

It is to be noted that while the example of advertising the behavior information by using the UPnP standard specification is indicated in the embodiment (1), other advertisement means such as using e.g. a specific advertisement message may be used if the information can be notified to the device on the home network 400.

Also, the proxy processor 25 of the above-mentioned gateway device 200X had to follow a prescribed sequence (behavior such as authentication processing, accounting procedure, and access restriction procedure), in order to communicate with the network server 300X. Therefore, the gateway device 200X may acquire from the network server 300X information (proxy processing behavior information) in which a behavior of proxy processing is described, and may operate based on this information.

Namely, in the retrieval process (see step S103) of the proxy processor 25 in the processing flow of FIG. 3, performing the authentication processing 722 with the network server 300X before transmitting the content retrieval message to the network server 300X is prescribed Also, in the purchase process (see step S104), when the terminal information (notification message) 731 is received from the terminal 100, the accounting procedure 732 is performed with the network 300X, and the access restriction procedure 733 is performed so as to be able to access the network server 300X from the terminal 100.

Therefore, the gateway device 200X acquires the proxy processing behavior information (sequence information; not shown but the same as that in FIG. 8) 704 of processing and procedure is acquired at step S100 in FIG. 4, so that in conformity with the proxy processing behavior information the proxy processor 25 may perform the processing and the procedure by proxy. The processing sequence control of the proxy processor 25 can be realized by the same mechanism as the terminal behavior information of the terminal 100.

It is to be noted that the type and process of the control messages 720a and 720b shown in the above description are not fixed but can be arbitrarily prescribed by prescribing the proxy processing behavior information by a service provider.

### Embodiment (2)

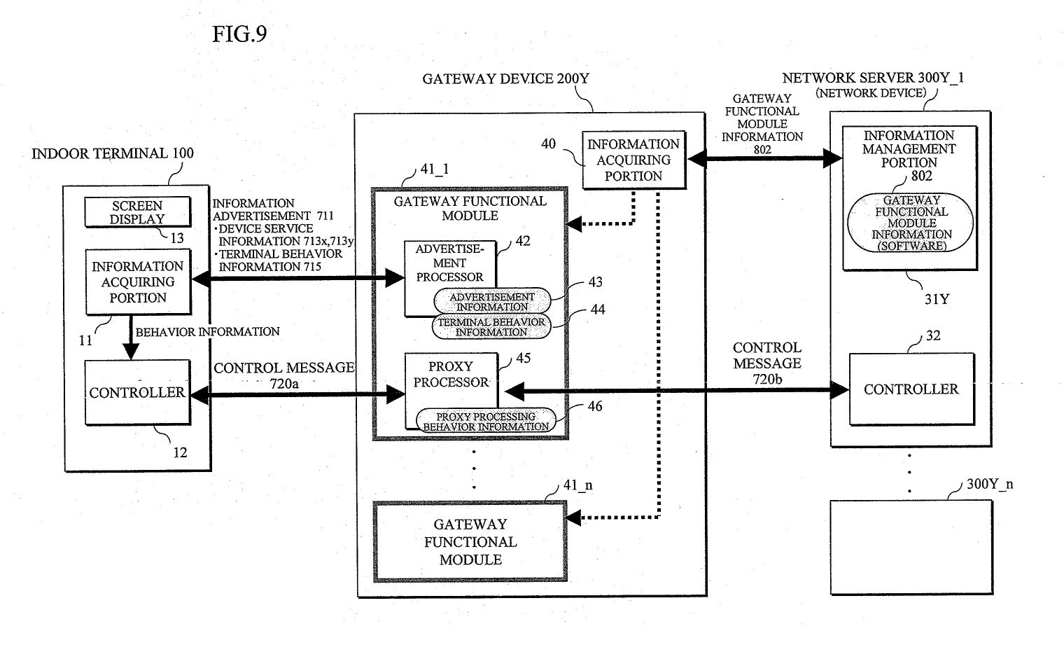

FIG. 9 shows the terminal 100, a gateway device 200Y, and a network server (network device) 300Y where the reference numeral 300Y represents reference numerals 300Y_1-300Y_2 according to the present invention. In the above-mentioned embodiment (1), the gateway functional portion 20 of the gateway device 200X has a general-purpose processing function, and is arranged so as to be operable in conformity with the server information and the proxy processing behavior information acquired from various network servers 300X. Namely, only a processing function of gateway function exists in the gateway device 200X, which is arranged so as to acquire from the network server 300X the behavior information indicating the specific processing content.

In this embodiment (2), the gateway device 200Y acquires from the network server 300Y the gateway function software module of a service provider unique specification. Namely, the gateway device 200Y acquires from the network server 300Y a set of behavior information indicating the processing function and processing contents.

The network device 300Y is provided with an information management portion 31Y and the controller 32. The information management portion 31Y holds and manages gateway functional module information (software) 802 including the terminal behavior information, the proxy processing behavior information, and the like, different from the information management portion 31X shown in FIG. 3 which holds only the terminal behavior information 703, the proxy processing behavior information 704, and the like. The controller 32 has the same function as the controller 32 shown in FIG. 3.

The gateway device 200Y is different from the gateway device 200X shown in FIG. 3 in that gateway functional modules (software) 41_1-41_2 (hereinafter, occasionally represented by a reference numeral 41) respectively acquired from the network devices 300_1-300_{—}n for the gateway functional portions 20_1-20_{—}n, and is provided with an information acquiring portion 40 which acquires the gateway functional modules 41_1-41_{—}n from the network devices 300Y_1-300Y_n.

The gateway functional module 41 includes an advertisement processor 42, advertisement information 43, terminal behavior information 44, a proxy processor 45, and proxy processing behavior information 46. The advertisement processor 42 and the proxy processor 45 respectively have the same function as that of the advertisement processor 22 and the proxy processor 25 shown in FIG. 3. The advertisement information 43, the terminal behavior information 44, and the proxy processing behavior information 46 are respectively the same as the advertisement information, the terminal behavior information, and the proxy processing behavior information stored in the advertisement information storing portion 23, the terminal behavior information storing portion 24, and the proxy processing behavior information storing portion 26 shown in FIG. 3.

The terminal 100 is the same as that shown in FIG. 3, and the control of the home network 400 which connects the terminal 100 and the gateway device 200 is the same as that in the embodiment (1).

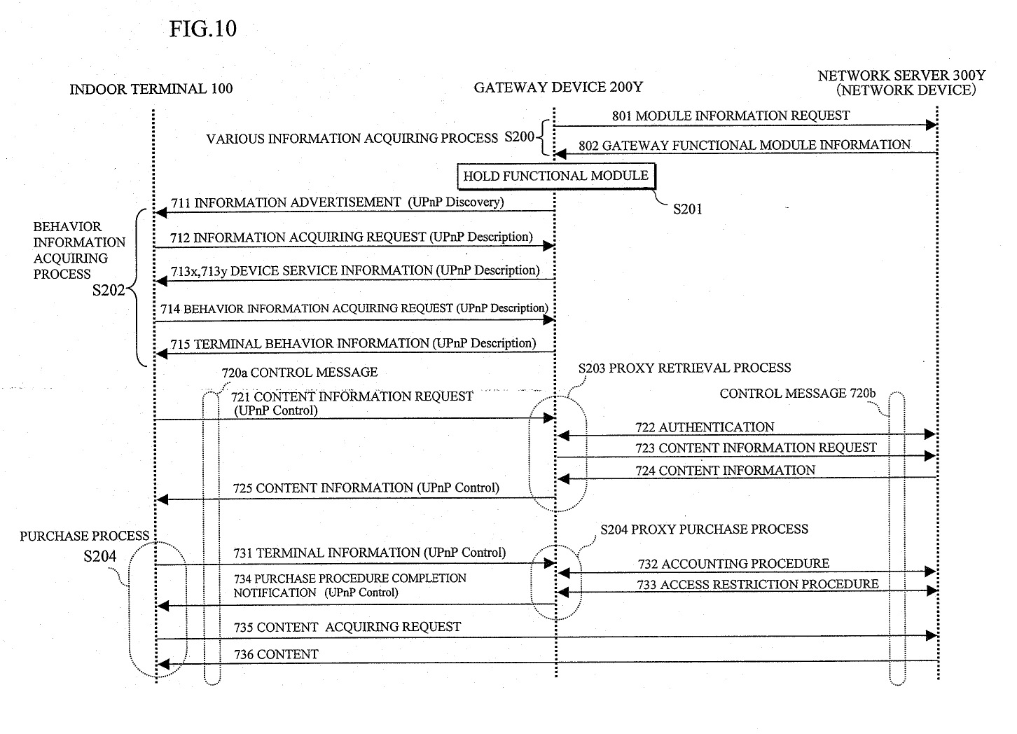

FIG. 10 shows an operation process example of the terminal 100, the gateway device 200Y, and the network device 300Y according to the present invention shown in FIG. 9. This operation process example is different from that of the embodiment (1) shown in FIG. 4 in that steps S200 and S201 substitute for steps S100 and S101 to be executed. The other steps S202-S204 are the same as steps S102-S104 in FIG. 4.

Hereinafter, the operation process of steps S200 and S201 will be described.

Step S200 (functional module acquiring process): In the gateway device 200Y, the information acquiring portion 40 transmits to the network server 300Y the module information request 801. In the network server (network device) 300Y, the information management portion 31Y returns the requested gateway functional module information 802.

Step S201: In the gateway device 200Y, the information acquiring portion 40 holds and mounts thereon the gateway functional module included in the acquired information 802.

Namely, at steps S200 and S201, the information acquiring portion 40 accesses the network server 300, downloads the gateway functional module information 802, and installs the gateway functional module (hereinafter, indicated by a reference numeral 41).

It becomes possible for the gateway device 200Y to execute subsequent steps S202-S204 by the advertisement processor 42 and the proxy processor 45, and with the terminal behavior information 44, the proxy processing behavior information 46, and the advertisement information 43 (information (server information) concerning the network server 300) of the gateway functional module 47. Accordingly, the operation other than the operation acquiring the functional module is the same as that of the embodiment (1). Also, the operations of the controller 32 of the network server 300Y, the information acquiring portion 11 and the controller 12 of the terminal 100 are the same as those in the embodiment (1).

### Embodiment (3)

In the above-mentioned embodiments (1) and (2), examples in which the gateway device 200 preliminarily holds the terminal behavior information, the proxy processing behavior information, and the like have been described. In this embodiment (3), the terminal behavior information, the proxy processing behavior information, and the like are directly notified from the network server 300. Namely, the gateway device 200 notifies the URI of the network server 300 to the terminal 100 of the home network 400 instead of the URI of the gateway device 200, as the terminal behavior information acquiring URI. Thus, it becomes possible for the terminal 100 to directly acquire the terminal behavior information from the network server 300. Also, as for the proxy processing behavior information of the proxy processor 25 of the gateway device 200, the gateway device 200 similarly holds only the URI for acquiring the proxy processing behavior information. Based on this URI, the proxy processor information may be acquired from the network server 300.

According to this embodiment (3), it becomes possible for the network server 300 to manage the behavior information in an integrated fashion, so that only the behavior information of the network server 300 has only to be updated in order to support the specification change of the behavior information.

What is claimed is:

1. A gateway device comprising:
a terminal behavior information storing portion storing terminal behavior information in which a behavior required for a terminal connected to a first network to use a network device connected to a second network is described; and
an advertisement processor providing the terminal behavior information to the terminal.

2. The gateway device as claimed in claim 1, further comprising an information acquiring portion acquiring the terminal behavior information from the network device to be stored in the terminal behavior information storing portion.

3. The gateway device as claimed in claim 1, further comprising a proxy processing behavior information storing portion storing proxy processing behavior information for performing processing required to use the network device for the terminal, and a proxy processor performing proxy processing, when a proxy request of processing for the network device is received from the terminal, based on the proxy processing behavior information corresponding to the proxy request by referring to the proxy processing behavior information storing portion.

4. The gateway device as claimed in claim 3, further comprising an information acquiring portion acquiring the proxy processing behavior information from the network device to be stored in the proxy processing behavior information storing portion.

5. The gateway device as claimed in claim 3, wherein the terminal behavior information also includes terminal behavior information for the terminal to request the proxy processor to perform proxy processing.

6. The gateway device as claimed in claim 1, wherein the terminal behavior information is compliant with a standard protocol of the first network.

7. The gateway device as claimed in claim 6, wherein the standard protocol is compliant with UPnP.

8. The gateway device as claimed in claim 1, further comprising an advertisement information storing portion storing advertisement information indicating information concerning the network device,
the advertisement processor advertising the advertisement information to the first network.

9. The gateway device as claimed in claim 8, wherein the advertisement processor provides the terminal behavior information to the terminal with a standard protocol of the first network.

10. The gateway device as claimed in claim 1, wherein the first network comprises a home network and the second network comprises Internet.

11. A gateway device comprising:
an information acquiring portion acquiring, from a network device on a second network, gateway functional module information including an advertisement processing function for providing a terminal with terminal behavior information in which a behavior required for the terminal on a first network to use the network device is described and a proxy processing function performing proxy processing, when a proxy request of processing for the network device is received from the terminal, based on proxy processing behavior information in which a behavior required to perform the behavior by proxy is described, in response to the proxy request; and
a storing portion storing the gateway functional module information to execute the advertisement processing function and the proxy processing function.

12. A terminal connected to a first network comprising:
an information acquiring portion acquiring, from a gateway device connected between the first network and a second network, terminal behavior information in which a behavior required to use a network device connected to the second network is described; and
a controller using the network device based on the terminal behavior information.

13. The terminal as claimed in claim 12, wherein the terminal behavior information includes behavior information in which a behavior to request the gateway device to perform behavior required to use the network device by proxy is described.

14. The terminal as claimed in claim 12, wherein the terminal behavior information is compliant with a standard protocol of the first network.

15. The terminal as claimed in claim 14, wherein the standard protocol is compliant with UPnP.

16. The terminal as claimed in claim 12, wherein the information acquiring portion acquires the terminal behavior information from the network device for the gateway device.

17. A network device comprising:
an information management portion managing terminal behavior information in which a behavior required to use the device itself is described and proxy processing behavior information in which a behavior required for a gateway device having received a proxy request of the behavior to perform the behavior by proxy is described, and returning both of the behavior information requested; and
a controller making the device itself available when a behavior based on the terminal behavior information or the proxy processing behavior information is received from a terminal or the gateway device.

18. A network device comprising:
an information management portion managing gateway functional module information including an advertisement processing function for providing a terminal with terminal behavior information in which a behavior required to use the device itself is described and a proxy processing function performing proxy processing, when a proxy request of processing for the device itself is received from the terminal, based on proxy processing behavior information in which a behavior required for a gateway device having received the proxy request of the behavior to perform the behavior by proxy is described, in response to the proxy request, and returning the gateway functional module information required; and
a controller making the device itself available when a behavior based on the terminal behavior information or the proxy processing behavior information is received from the terminal or the gateway device.

19. A network device comprising:
a behavior information management portion managing terminal behavior information in which a behavior required to use the device itself is described or proxy processing behavior information in which a behavior required for a gateway device having received a proxy request of the behavior to perform the behavior by proxy is described; and
an advertisement processor advertising a URI of the device itself for acquiring the behavior information to a terminal or the gateway device.
